(19) United States
(12) Patent Application Publication
(10) Pub. No.: US 2024/0227044 A1
(43) Pub. Date: Jul. 11, 2024

(54) WIRE SAW AND SYSTEM COMPRISING A WIRE SAW AND A REMOTE CONTROL, AND METHOD AND USE OF AN ACTUATING DEVICE FOR TAUTENING A SAW WIRE IN A WIRE SAW

(71) Applicant: Hilti Aktiengesellschaft, Schaan (LI)

(72) Inventors: Hans-Joerg RIEGER, Thueringen (AT); David PLATTNER, Gallzein (AT)

(21) Appl. No.: 18/280,752

(22) PCT Filed: Mar. 7, 2022
(86) PCT No.: PCT/EP2022/055667

§ 371 Date: Sep. 7, 2023

(30) Foreign Application Priority Data
Mar. 19, 2021 (EP) 21163655.0

(51) Int. Cl. B23D 57/00

(52) U.S. Cl. CPC B23D 57/0007; B23D 57/0069

(57) ABSTRACT

A wire saw having a wire drive and a wire store for a saw wire, in which an actuating device for tautening the saw wire is arranged on a drive and storage unit of the wire saw. Also provided is a system made up of a wire saw and a remote control device, wherein the actuating device is a constituent of the remote control device. The invention relates to a method, and to the use of an actuating device for tautening a saw wire in a wire saw, wherein the actuating device is arranged on a drive and storage unit of the wire saw or is a constituent of a remote control device.

The present invention relates to a wire saw having a wire drive and a wire store for a saw wire.

### BACKGROUND

Wire saws, as they are known, with which large cuts can be made, for example in walls, are known from the prior art. Wire saws usually have a saw wire in the form of an endless saw wire, which is guided inside the wire saw over various rollers and tensioned. At least some of these rollers form a wire store in which the saw wire can be stored. Furthermore, a tensioning and spreading mechanism can be provided, with which the saw wire can be kept taut. While it is being used, the saw wire is subject to significant mechanical loads, wherein in particular uniform wearing of the saw wire is desired. As a result, it is possible for example to reduce the probability or the risk of undesired rupturing of the saw wire. The rollers or deflection rollers of the wire store of the wire saw have guide slots as running grooves, wherein the saw wire is preferably guided in these running grooves. The wire drive, and the wire store can be enclosed by a housing, wherein, as a result, a drive and storage unit of the wire saw is formed.

In order that the saw wire wears down as roundly, i.e. uniformly, as possible, it is known from the prior art to wind up the saw wire before the wire loop is connected. This winding up of the saw wire promotes loop formation of the saw wire, wherein this loop formation has the result that the saw wire cannot be held without additional tautening in the guide slots of the wire rollers.

In conventional wire saws, as are known from the prior art, actuating devices are provided, with which tautening of the saw wire can be brought about or initiated. These actuating devices may be formed for example by a button or comprise a button. As a rule, the known actuating devices for wire tautening are arranged on a control panel which, for safety reasons, is located for example several meters away from the actual wire saw. This means that known actuating devices for wire tautening are not arranged directly on the drive and storage unit of the wire saw but are usually a constituent of a control panel which is usually arranged at least several meters away from the wire saw. This distance means that at least two persons are required to fit the wire into the wire store, namely a first person, who tautens the wire at the drive and storage unit of the wire saw, and a second person, who actuates the actuating device for tautening the saw wire at the control panel.

### SUMMARY OF THE INVENTION

The described procedure for preparing the wire saw for operation involves a large amount of personnel and is thus costly. An object on which the present invention is thus based is that of overcoming the above-described defects and drawbacks of the prior art and of providing a wire saw which can be operated with fewer personnel. In particular, it is intended to be easier to prepare the wire saw for operation.

According to the invention, a wire saw having a wire drive and a wire store for a saw wire is provided. The wire saw is characterized in that an actuating device for tautening the saw wire is arranged on the drive and storage unit of the wire saw (“first configuration of the invention”). For the purposes of the invention, this preferably means that the actuating device for tautening the saw wire is not provided on a preferably fixed control panel, but rather is a constituent of the wire saw itself. Such preferably fixed control panels are known from the prior art and are used to control wire saws. It is from such wire saw systems having a control panel that the invention deviates. This is achieved in particular in that the actuating device for wire fitting is arranged on the drive and storage unit of the wire saw. As a result, the particular advantage of the invention can be achieved that, to fit the wire in the wire store of the wire saw only one person is required, with the result that the amount of personnel for operating the wire saw can be considerably reduced. The one person can keep the saw wire taut in the region of the wire saw for introducing the saw wire and preferably at the same time actuate the actuating device for tautening the saw wire, since this is advantageously arranged on the drive and storage unit of the wire saw.

By way of the invention, it is advantageously possible for the wire saw to be able to be operated with much fewer personnel. In particular, by way of the invention, the preparation of the wire saw for operation can be made much simpler with fewer personnel in that the fitting of the wire in the wire store is simplified.

The same advantageous effect that only one person is required for preparing the wire saw for operation can be achieved in that the actuating device is a constituent of a remote control device (“second preferred configuration of the invention”). In this case, the one person can introduce the saw wire into the wire store of the wire saw and preferably at the same time actuate an actuating element of the actuating device for tautening the saw wire. As a result the saw wire is tautened and only one person is required to prepare the wire saw for use. Both configurations of the invention have in common that the actuating device is not arranged on a fixed control panel. Thus, the invention relates in particular to a wire saw in which an actuating device is not arranged on a fixed control panel, wherein this control panel is usually arranged a few meters away from the wire saw. In the first configuration of the invention, to activate wire tensioning for fitting the wire in the store, the communication link, i.e. the radio link, can be deactivated, with the result that undesired restarting of the wire saw is effectively prevented. In the context of the second preferred configuration of the invention, an active radio link is provided, and so it is necessary to prevent unintentional switching on or unintentional restarting via additional measures.

The actuating device is in particular an actuating device which is used for wire fitting. In the context of the wire saw, it is also possible for other actuating devices with a different functionality to be provided, and so, for the purposes of the invention, the actuating device is preferably also referred to as “further actuating device”.

For the purposes of the invention, it is preferred that the system has at least two actuating devices, wherein a first actuating device can be provided on the drive and storage unit of the wire saw and a second actuating device can be provided on a remote control device. Preferably, as a result of actuation of the actuating devices, the tensile force of the saw wire can be set or changed. For the purposes of the invention, it is preferred that the actuating device on the drive and storage unit of the wire saw is used in particular for wire fitting or for fitting the wire in the store. For the purposes of the invention, it is preferred that, while the store of the wire saw is being fitted with the wire, there is no communication link between the wire saw and the remote control device. In other words, for the purposes of the invention, it is preferred that the remote control device is deactivated during wire fitting. During operation of the wire saw, the user of the system preferably remains outside a hazardous region of the wire saw and can control the latter during operation by way of the remote control device. The user can in particular change or adapt a pressure on the actuating device. This can take place conveniently and safely, during operation of the wire saw, using the remote control device and outside the hazardous region of the wire saw. In particular, for this adaptation of the pressure, the actuating device on the remote control can be used.

In the context of the invention, a wire saw is thus disclosed, in which the further actuating device is either arranged on a drive and storage unit of the wire saw itself or is a constituent of a remote control device.

For the purposes of the invention, it is preferred that the actuating device is provided to set a tension in the saw wire. In other words, the tautening of the saw wire corresponds to the setting of a preferably increased wire tension or a high value of the wire tension. If the tension in the saw wire is intended to be reduced or eliminated, it is possible for example for a lower value to be set for the tension in the saw wire. For the purposes of the invention, it is preferred that a high value for the tension of the saw wire corresponds to a tensioned state of the saw wire, while a low value for the tension in the saw wire corresponds to a relaxed state of the saw wire. For the purposes of the invention, it is preferred that a tension in the saw wire or a value for the wire tension can be set by means of the actuating device.

For the purposes of the invention, it is preferred that opening of the protective cover lowers the tensioning force of the saw wire. As a result of the lowering of the wire tensioning force, it is advantageously possible for the risk of injury to the operator of the wire saw to be able to be reduced considerably. The remaining wire tensioning force is preferably still high enough, however, for the saw wire to remain reliably in the guide slots of the rollers of the wire store.

For the purposes of the invention, it is preferred that a long actuation of the actuating device causes the tension in the saw wire to be eliminated. In other words, this preferably means that the saw wire is preferably no longer under tension.

Preferably, a relatively long actuation of the actuating device can cause the wire saw to be put into a state in which it is possible to fit the wire store with wire. This state for fitting the store with wire can preferably be achieved in that the store closes up. For the purposes of the invention, this preferably means that a distance between the rollers of the wire store becomes smaller in that the rollers are moved toward one another. This process takes place preferably slowly and with little force. Brief actuation of the actuating device can cause the store to open out again. For the purposes of the invention, this preferably means that a distance between the rollers of the wire store is increased in that the rollers are moved away from one another. In other words, the rollers of the wire store move apart from one another or they are pulled apart. As a result of this pulling apart of the wire store or of the rollers of the wire store, the wire loop of the saw wire can be tautened. The wire loop can in particular be tautened until the saw wire is held securely in the guide slots of the rollers again. Therefore, for the purposes of the invention, it is preferred that brief, further actuation of the actuating device results in the saw wire being tautened, wherein the tautening of the saw wire in particular causes the saw wire to pass into the guide slots of the wire store.

For the purposes of the invention, it is preferred that, after the protective cover has been closed, the wire tension is increased again. This increase in the wire tension following closure of the cover can lie for example in a range from 5 to 20% of the initial tension in the saw wire. For the purposes of the invention, it is preferred that the wire tension does not drop below a preferably preset minimum value.

This increased wire tension advantageously makes it possible to check alignment of the guide rollers at the machine input and/or at the machine output with the deflection rollers attached to the component. In other words, closure of the cover of the drive and storage unit of the wire saw results in an automatic increase in the tension in the saw wire. For the purposes of the invention, it is particularly preferred that actuation of the actuating device correlates with fixed values for a tensioning force and/or a releasing force of the saw wire, in order to avoid misapplications. The correlation between the actuation of the actuating device and the preferably fixed tensioning forces and/or the preferably fixed releasing forces of the saw wire consists in particular in that actuation of the actuating device results in application of the preferably fixed tensioning and/or releasing forces.

For the purposes of the invention, it is preferred that it is not possible to change a tension in the saw wire of the wire saw with the cover of the wire saw open. In other words, the wire saw is preferably set up such that the tension on the saw wire cannot be further increased by an operator when the cover of the drive and storage unit of the wire saw is open.

For the purposes of the invention, it is preferred that the wire saw has a cover for the wire store, wherein a predefined, preferably low, wire tension is settable when the cover is opened. For the purposes of the invention, it is preferred that the wire tension is set automatically, wherein, in the context of the present invention, in particular a low wire tension is set when the cover of the wire store is opened. This setting preferably takes place automatically when the wire saw identifies that the wire store cover is being opened. As a result of a preferably preset or predefined low value being set for the wire tension, a risk of injury to a user of the wire saw can advantageously be reduced considerably. This is the case in particular when a hand of the user or operator gets between a roller of the wire store and the saw wire. In this configuration of the invention, it is preferred that the tensioning pressure on the saw wire is set preferably automatically to a predefined, low value when the store cover is opened. In this way, the risk of injury to the operator of the wire saw can be reduced substantially.

It is alternatively or additionally preferred that a high wire tension can be set when the cover of the wire store is closed. This setting also takes place preferably automatically when it is identified that the wire store cover is being closed. For the purposes of the invention, it is preferred that the wire tension is raised preferably automatically when the cover of the wire store is closed. This can advantageously be achieved in that the saw wire can be tautened and correct wire guidance can be checked or monitored.

In a second aspect, the invention relates to a system comprising a wire saw and a remote control device, wherein the actuating device is a constituent of the remote control device. Wire saw systems in which the actuating device is provided on such a, for example fixed, control panel are known from the prior art. It is from such wire saw systems having a control panel that the invention deviates in that, in the context of the present invention, the actuating device for tautening the saw wire is specifically not provided on the fixed control panel. This can be achieved for example in that the actuating device is arranged on a drive and storage unit of the wire saw or is only a constituent of a remote control device. The terms, definitions and technical advantages introduced for the wire saw apply in an analogous manner to the system. The wire saw which is a constituent of the system is preferably a different wire saw than the wire saw. While the wire saw corresponds preferably to the first configuration of the invention, the wire saw of the system is a wire saw which corresponds to the second preferred configuration of the invention.

For the purposes of the invention, it preferred that there is a communication link between the wire saw and the remote control device. In particular, the communication link may be wireless.

For the purposes of the invention, it is preferred that the remote control device can be carried by a user of the system. In other words, it may advantageously be a portable remote control device. It is also possible for example for the actuating device to be electronic and to be integrated in application software (an “app”), wherein the application software can be run on a mobile communication device. As a result, a commonly used electronic device, such as a mobile communication device, can be used as remote control device for a wire saw.

In a further aspect, the invention relates to a method for tautening a saw wire in a wire saw. The terms, definitions and technical advantages introduced for the wire saw and the system apply in an analogous manner to the method. The method is characterized by the following steps of:
a) providing a wire saw OR providing a system,
b) introducing the saw wire into a wire store of the wire saw,
c) actuating an actuating device to tauten the saw wire, with the result that the saw wire is tautened.

An essential advantage of the method is that the method can be carried out by only one user. This means that only one person is required to carry out the method, wherein this one person preferably simultaneously tensions the saw wire within the wire store of the wire saw manually and actuates the actuating device, with the result that the saw wire is further tautened. Preferably, the actuating device for tautening the saw wire is arranged on a drive and storage unit of the wire saw or is a constituent of a remote control device. The actuating device for tautening the saw wire is in particular not arranged on a fixed control panel, together with which the wire saw can be operated.

In yet another aspect, the invention relates to the use of an actuating device for tautening a saw wire in a wire saw, wherein the actuating device is arranged on a drive and storage unit of the wire saw or is a constituent of a remote control device.

Further advantages will become apparent from the following description of the figures. The figure, the description and the claims contain numerous features in combination. A person skilled in the art will expediently also consider the features individually and combine them to form useful further combinations.

### BRIEF DESCRIPTION OF THE DRAWINGS

Identical and similar components are denoted by the same reference signs in the figure, in which:

FIG. 1 shows a view of a preferred configuration of the wire saw

FIG. 2 shows a view of a preferred configuration of the system

### DETAILED DESCRIPTION

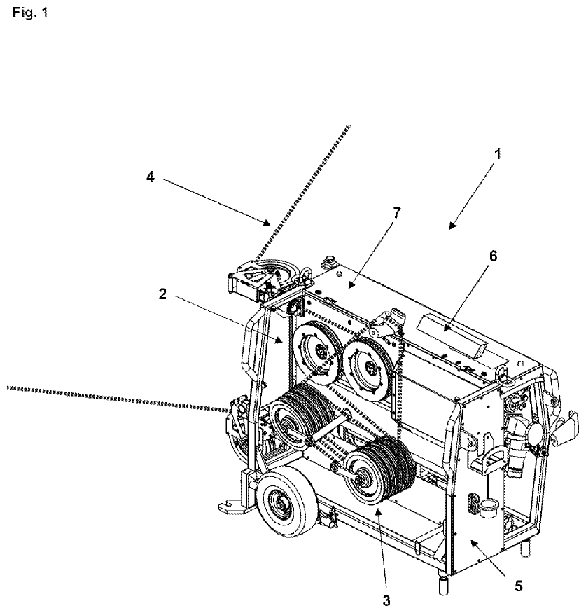

FIG. 1 shows a preferred configuration of the wire saw 1. The wire saw 1 comprises a wire drive 2 and a wire store 3, wherein the wire store 3 may comprise rollers and/or deflection rollers. The wire drive 2 and the wire store 3 are preferably arranged on a drive and storage unit 5 of the wire saw 1, wherein the drive and storage unit 5 preferably forms the main body of the wire saw 1. The wire store 3 is designed to receive and store the saw wire 4 of the wire saw 1. Using the wire drive 2, the saw wire 4 can be driven. The wire store 3, or the drive and storage unit 5, can have a cover 7, which, for the purposes of the invention, is preferably also referred to as wire store cover 7. The wire saw 1 has an actuating device 6 for tautening the saw wire 4, wherein this actuating device 6 is arranged on the drive and storage unit 5 of the wire saw 1 in the exemplary embodiment of the invention that is illustrated in FIG. 1. Of course, the actuating device 6 is arranged such that the operator, while manually tautening the wire 4, can reach the actuating device 6. Furthermore, different embodiments of the actuating device 6 are conceivable.

In the context of the invention, the actuating device 6 can be arranged on the drive and storage unit 5 of the wire saw 1. As a result of this arrangement, the wire tension can be activated even with an inactive radio link. This technical effect of the arrangement of the actuating device on the drive and storage unit 5 of the wire saw 1 has been found to be an essential advantage of the invention, since, for example, unintentional switching on of the wire drive, and unintentional restarting of the saw, can be prevented particularly effectively.

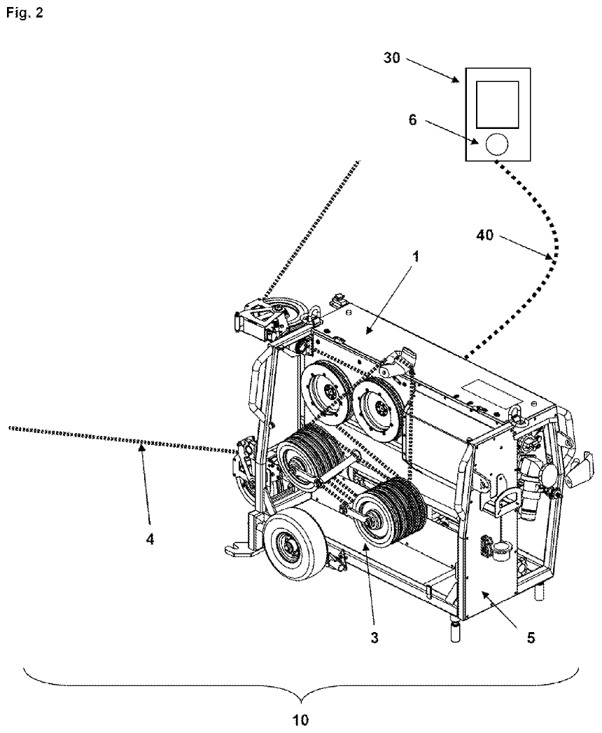

FIG. 2 shows a preferred configuration of the system 10. The system 10 comprise a wire saw 1 and remote control device 30, wherein the actuating device 6 is a constituent of the remote control device 30 in the exemplary embodiment of the invention illustrated in FIG. 2. For the purposes of the invention, it is preferred that there is a communication link 40 between the remote control device 30 and the wire saw 1, in particular the drive and storage unit 5 thereof. This communication link 40 is preferably wireless. In the configuration of the invention that is depicted in FIG. 2, the actuating device 6 is in particular not a constituent of a fixed control panel (not illustrated).

In the exemplary embodiment of the invention that is illustrated in FIG. 2, the drive and storage unit 5 does not have an actuating device 6 on the drive and storage unit 5, but rather the actuating device 6 is arranged on a remote control 30. For the purposes of the invention, it is preferred that a tension in the saw wire 4 is set or established via the actuating device 6 on the remote control device 30. Preferably, in this configuration of the invention, there is an activated radio link, and so for example other functions of the wire saw 1 can also be triggered. In order to avoid unintentional switching on of the wire saw 1 when wire is being fitted in the wire store 3, it is preferred, for the purposes of the invention, that a control program of the wire saw 1 meets high safety standards. As a result, in particular undesired automatic starting of the wire saw 1 can be effectively avoided. The control program of the wire saw 1 can be realized for example as a computer program product and be run on the drive and storage unit 5 of the wire saw 1.

For the purposes of the invention, it is preferred that the wire saw 1 can be controlled with the remote control device 30 in that inputs are performed on the remote control 30, these having an effect on the wire saw 1. For the purposes of the invention, it is very particularly preferred that the remote control 30 has an actuating device 6 with which the saw wire 4 of the wire saw 1 can be tautened. The processes within the wire saw 1 which result in tautening or less intense tautening of the saw wire 4 are substantially the same for the different embodiments.

Preferably, in particular when wire is being fitted in the wire store 3, there is a communication link 40 between the wire saw 1 and the remote control device 30.

### LIST OF REFERENCE SIGNS

1 Wire saw
2 Wire drive
3 Wire store
4 Saw wire
5 Drive and storage unit of the wire saw
6 Actuating device
7 Cover for the wire store
10 System
30 Remote control device
40 Communication link

1-12. (canceled)

13. A wire saw comprising:
a wire drive;
a wire store for a saw wire, the wire drive and the wire store defining a drive and storage unit; and
an actuator for tautening the saw wire arranged on the drive and storage unit.

14. The wire saw as recited in claim 13 wherein the actuator is provided to set a tension in the saw wire.

15. The wire saw as recited in claim 13 further comprising a cover for the wire store, a wire tension lower than an operating wire tension being settable when the cover is opened.

16. The wire saw as recited in claim 15 wherein the operating wire tension is settable when the cover is closed.

17. A system comprising:
a wire saw having a saw wire; and
a remote control, an actuator for tautening the saw wire being a constituent of the remote control.

18. The system as recited in claim 17 further comprising a communication link between the wire saw and the remote control.

19. The system as recited in claim 18 wherein the communication link is wireless.

20. The system as recited in claim 17 wherein the remote control is carryable by a user of the system.

21. A method for tautening a saw wire in a wire saw, the method comprising:
a) providing a wire saw with a saw wire, the wire saw being as recited in claim 13 or the wire saw being provided as part of a system comprising the wire saw and a remote control;
b) introducing the saw wire into the wire store of the wire saw; and
c) actuating an actuator of the wire saw with the result that the saw wire is tautened.

22. The method as recited in claim 21 wherein the actuator is arranged on a drive and storage unit of the wire saw or is a constituent of the remote control.

23. The method as recited in claim 21 wherein the method is carried out by only one user.

24. A method for using an actuator for tautening a saw wire in a wire saw, comprising actuating the actuator while the actuator is arranged on a drive and storage unit of the wire saw or is a constituent of a remote control.
